(19) United States
(12) Patent Application Publication
(10) Pub. No.: US 2005/0248321 A1
(43) Pub. Date: Nov. 10, 2005

(54) Fly wheel energy storage system

(76) Inventors: Benrong Liu, Shanghai (CN); Chunyuan Zhou, Shanghai (CN); Ping Liu, Shanghai (CN); Jie Zhou, Shanghai (CN)

Correspondence Address: ARTHUR KING MA, 1030 CORONADO DRIVE, ARCADIA, CA, 91007, US

(21) Appl. No.: 10/961,711

(22) Filed: Oct. 7, 2004

(30) Foreign Application Priority Data
May 10, 2004 (CN) 200410018193.X

(51) Int. Cl. H02K 7/02; B62M 1/10; B60K 6/00

(52) U.S. Cl. 322/4

(57) ABSTRACT

A flywheel energy storage system includes a driving wheel rotatable relative to a first axis; an electric motor for driving the driving wheel; an electric generator; a driven wheel adapted to drive the electric generator; a flywheel rotatable relative to a second axis parallel to the first axis; a clutch assembly for engagement or disengagement of the flywheel and the driven wheel; and a transmission gear train assembly engagingly interposed between the flywheel and the driving wheel adapted for conveying kinetic energy from the driving wheel to the flywheel. The transmission gear assembly is provided for allowing the flywheel driven by a low-powered electric motor to drive a high-powered electric generator.

### BACKGROUND OF THE INVENTION

1. Field of the Invention

The present invention relates to flywheel energy storage systems, and more particularly to a flywheel energy storage system utilizing a transmission gear assembly for allowing an energy storage flywheel driven by a low-powered electric motor to drive a high-powered electric generator.

2. Description of Prior Art

It is well known that a flywheel energy storage system is a mechanical device that converts electrical energy into kinetic energy and, when necessary, converts the kinetic energy back to electrical energy. In other words, it acts like a chemical battery but with many advantages when compared to a traditional chemical battery. Compared with traditional batteries, flywheel energy storage systems store energy very efficiently and have very high output potential and relatively long life. Furthermore, the flywheel energy storage systems are relatively unaffected by ambient temperatures.

A conventional flywheel energy storage system generally comprises a flywheel suspended inside a vacuum chamber, and an energy converting device which is generally a combination of an electric motor and an electric generator. In operation, the energy converting device takes an electrical input to accelerate the flywheel up to speed by using the electric motor and maintaining the energy in the system as inertial energy, and return the electrical energy by using this same electric motor as the electric generator. Since the electric generator and the electric motor are essentially of the same device, in order to supply electrical energy at a desired high power by the electric generator, a high-powered electric motor has to be employed, accordingly.

### SUMMARY OF THE INVENTION

Accordingly, an object of the present invention is to provide a flywheel energy storage system utilizing a transmission gear assembly for allowing a flywheel driven by a low-powered electric motor to drive a high-powered electric generator.

In order to achieve the aforementioned object, a flywheel energy storage system according to the invention includes a driving wheel rotatable relative to a first axis; an electric motor for driving the driving wheel; an electric generator for supplying electrical power; a flywheel rotatable relative to a second axis parallel to the first axis; a clutch assembly for engagement or disengagement of the flywheel and the electric generator; and a transmission gear train assembly engagingly interposed between the flywheel and the driving wheel adapted for conveying a driving force from the driving wheel to the flywheel.

In one aspect of the present invention, the transmission gear assembly includes a common transmission shaft rotatable about a third axis parallel to the first and second axes; a first gear train comprising a first input gear adapted to be driven by the driving wheel, a first output gear coupled to the flywheel, a first compound gear coupled to the common transmission shaft, the first compound gear having a small diameter gear portion meshing with the first input gear and an coaxial larger diameter gear portion meshing with the first output gear; and a second gear train comprising a second input gear coupled to the common transmission shaft, a second output gear adapted to drive the flywheel, a second compound gear having a small diameter gear portion meshing with the second input gear and an coaxial larger diameter gear portion meshing with the second output gear.

In another, aspect of the present invention, the transmission gear train assembly includes a common transmission shaft rotatable about a third axis parallel to the first and second axes; a first gear train comprising a first input gear adapted to be driven by the driving wheel, a first output gear coupled to the flywheel, at least two first compound gears meshing with each other, each of the first compound gears including a small diameter gear portion and an coaxial large diameter gear portion, wherein a first compound gear nearest the first input gear is coupled to the common transmission shaft, the at least two first compound gears are assembled as one unit in a manner that a larger diameter gear portion of one of two neighboring first compound gears meshes with a small diameter gear portion of the other and a small diameter gear portion of a first compound gear nearest to the first input gear meshes with the first input gear and a large diameter gear portion of a first compound gear nearest to the first output gear meshes with the first output gear; and a second gear train comprising a second input gear coupled to the common transmission shaft, a second output gear adapted to drive the flywheel, and at least two second compound gears meshing with each other, each of the second compound gears including a small diameter gear portion and an coaxial large diameter gear portion, wherein the at least two first compound gears are assembled as one unit in a manner that a larger diameter gear portion of one of two neighboring second compound gears meshes with a small diameter gear portion of the other and a small diameter gear portion of a second compound gear nearest to the second input gear meshes with the second input gear and a large diameter gear portion of a second compound gear nearest to the second output gear meshes with the second output gear.

The above and other features of the invention, including various novel details of construction and combination of parts, will now be more particularly described with reference to the accompanying drawings, in which.

### BRIEF DESCRIPTION OF THE DRAWINGS

FIG. 1 is a schematic view of a flywheel energy storage system in accordance with a preferred embodiment of the present invention; and

FIG. 2 is a schematic view showing interrelationships between a driven sprocket wheel, a flywheel, a transmission gear train assembly, and a driving wheel.

### DETAILED DESCRIPTION OF PREFERRED EMBODIMENT

Reference will now be made to the drawings to describe the present invention in detail.

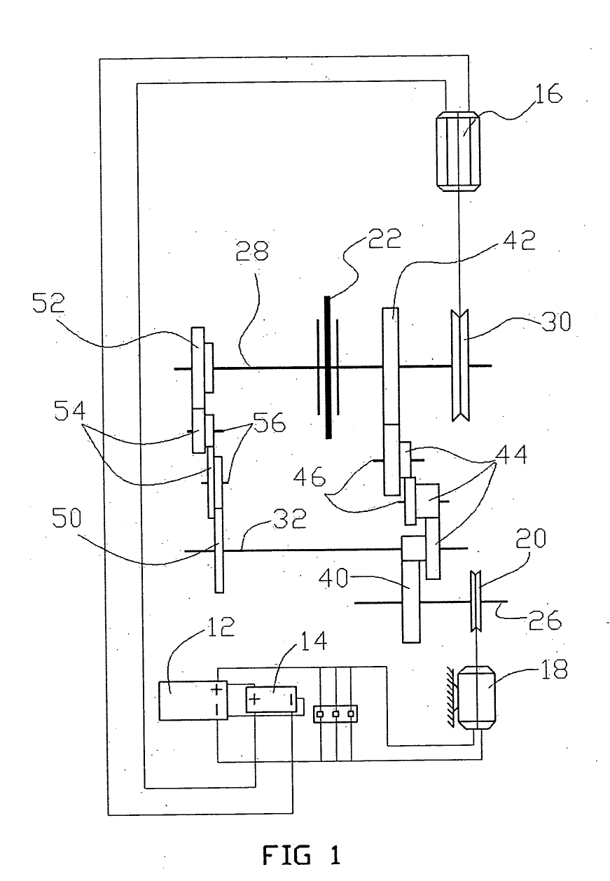

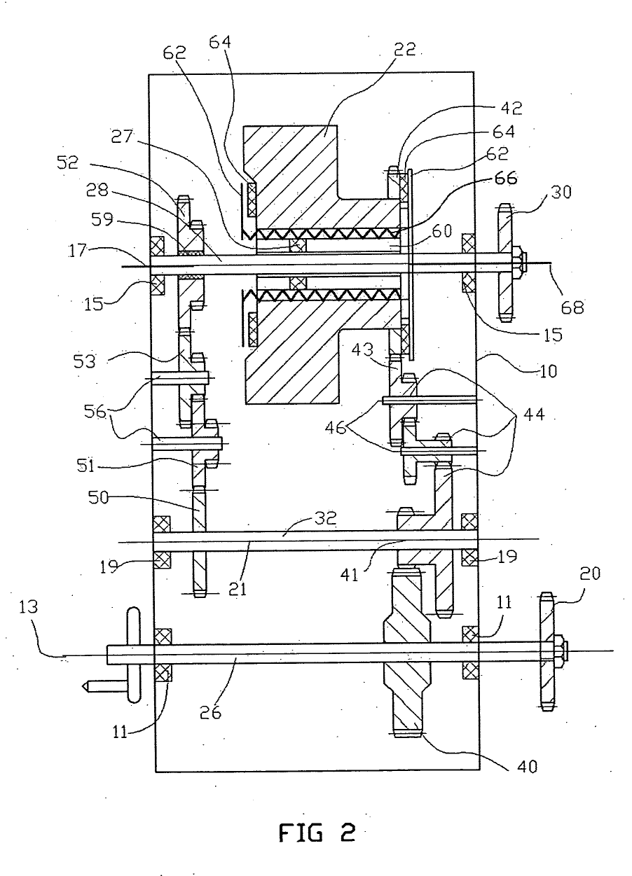

Referring initially to FIG. 1, a flywheel energy storage system in accordance with a preferred embodiment of the present invention comprises a frame 10 (shown in FIG. 2), a storage battery 12, a battery charger 14, an electric generator 16, an electric motor 18, a driving wheel 20, a flywheel 22, a driven wheel 30 and a transmission gear train assembly (not labeled).

The storage battery 12 is provided for supplying power to the electric motor 18 or customer's loads. The battery charger 14 is electrically connected to the storage battery 12 for charging the storage battery 12. The electric motor 18 is provided for driving the driving wheel 20.

With reference to FIG. 2, a driving shaft 26 is coupled to the frame 10. Opposite ends of the driving shaft 26 are engaged with and supported by two bearings 11 mounted on the frame 10. The driving shaft 26 is elongated along and rotatable about a first axis 13. The driving wheel 20 is fixedly mounted on a distal end of the driving shaft 26 for coaxial rotation therewith. Similarly, a driven shaft 28 is coupled to the frame 10. Opposite ends of the driven shaft 28 are engaged with and supported by two bearings 15 mounted on the frame 10. The driven shaft 28 is elongated along and rotatable about a second axis 17 parallel to the first axis 13. The driven wheel 30 is generally a sprocket wheel that is fixedly mounted to one distal end of the driven shaft 28 for rotation therewith. The driven sprocket wheel 30 is connected to the electric generator 16 by means of an endless chain (not shown).

A transmission gear assembly is arranged between the flywheel 22 and the driving wheel 20. The transmission gear assembly comprises a common transmission shaft 32, a first gear train and a second gear train.

The common transmission shaft 32 is coupled to the frame 10 and is located adjacent the driving shaft 26. Opposite ends of the transmission shaft 32 are engaged with and supported by two bearings 19 mounted on the frame 10. The common transmission shaft 32 is elongated along and rotatable about a third axis 21 parallel to the first and second axes 13, 17.

The first gear train includes a first input gear 40, a first output gear 42, and three first compound gears 44 meshing with each other. The first input gear 42 is fixedly mounted on the driving shaft 26 for coaxial rotation therewith. The first output gear 42 is fixedly mounted to a first end of the flywheel 22 for coaxial rotation therewith. Each of the first compound gears 44 includes a small diameter gear portion and an integral coaxial large diameter gear portion. The first compound gears 44 are assembled as one unit in a manner that a larger diameter gear portion of one of two neighboring first compound gears 44 meshes with a small diameter gear portion of the other so as to achieve a desired high gear ratio. A small diameter gear portion 41 of a first compound gear 44 nearest to the first input gear 40 meshes with the first input gear 40. A large diameter gear portion 43 of a first compound gear 44 nearest to the first output gear 42 meshes with the first output gear 42. The first compound gear 44 nearest to the first input gear 40 is mounted on the common transmission shaft 32. The other two first compound gears 44 are correspondingly mounted on two first cantilever shafts 46 coupled to the frame 10. The first cantilever shafts 46 are aligned parallel to the common transmission shaft 32.

Similarly, the second gear train includes a second input gear 50, a one-way bearing 59, a second output gear 52, and two second compound gears 54 meshing with each other. The second input gear 50 is fixedly mounted to the common transmission shaft 32 for coaxial rotation therewith. The second output gear 52 is mounted to the other distal end of the driven shaft 28 and supported by the one-way bearing 59. The one-way bearing 59 is provided for allowing the first and second output gears 42, 52 to rotate at differential speeds. Each of the second compound gears 54 includes a small diameter gear portion and an integral coaxial large diameter gear portion. The second compound gears 54 are assembled as one unit in a manner that a larger diameter gear portion of one of two neighboring second compound gears meshes with a small diameter gear portion of the other so as to achieve a desired high gear ratio. A small diameter gear portion 51 of a second compound gear 54 nearest to the second input gear 50 meshes with the second input gear 50. A large diameter gear portion 53 of a second compound gear 54 nearest to the second output gear 52 meshes with the second output gear 52. The second compound gears 54 are correspondingly mounted on two second cantilever shafts 56 coupled to the frame 10. The second cantilever shafts 56 are aligned parallel to the common transmission shaft 32.

It should be noted that the number of the first and second compound gears 44, 54 of the transmission gear train assembly is not limited to the present embodiment. For instance, the first gear train may include a first input gear adapted to be driven by the driving wheel, a first output gear coupled to the flywheel, and a first compound gear coupled to the common transmission shaft. The first compound gear has a small diameter gear portion meshing with the first input gear and an integral coaxial larger diameter gear portion meshing with the first output gear. Similarly, the second gear train includes a second input gear coupled to the common transmission shaft, a second output gear adapted to drive the flywheel, and a second compound gear having a small diameter gear portion meshing with the second input gear and an coaxial larger diameter gear portion meshing with the second output gear.

A clutch assembly is provided for engagement or disengagement of the flywheel 22 and the driven shaft 28. The clutch assembly includes a cylindrical main body 60, clutch plates 62 affixed to opposite end surfaces of the flywheel 22, two pressure plates 64 attached to opposite ends of the main body 60, a plurality of spring member 66 arranged between the pressure plates 64. The clutching assembly is controlled by an operation lever 68. The clutching assembly described above may have other configurations and arrangements that are all conventional and well known to those skilled in the art and will not be discussed in detail.

The flywheel 22 is supported a bearing 27 mounted on the main body 60 of the clutch assembly. The flywheel 22 is a massive disc, and is generally made of high-tensile-strength fibers embedded in epoxy resins, or some other high-strength composite. The flywheel 22 stores kinetic energy by driving the electric motor 16 to increase a speed of the spinning flywheel 22. The flywheel 22 provides power by using momentum of the flywheel 22 to power the electric generator 16.

As would be readily understood, the aforementioned gear configuration may be substituted with a wheel and belt configuration, which should be considered within the scope of the present invention.

In operation, when the clutching assembly is disengaged, the flywheel 22 is decoupled from the driven shaft 28. The driving wheel 30 is driven to rotate freely relative to the driving shaft 28 by the transmission gear train assembly. Due to the higher gear ratio provided by the transmission gear assembly, the flywheel 22, when storing kinetic energy, can be driven by means of a low-powered electric motor 18, and when releasing kinetic energy, drives a high-powered electric generator 16. Over a period of time, the kinetic energy is accumulated and stored in the flywheel 22. When the clutching assembly is engaged, the flywheel 22 is coupled to the driven shaft 28. The flywheel 22 drives the driven shaft 28 and the driven sprocket wheel 30 to rotate. The driven sprocket wheel 30, in turn, powers the electric generator 16 for supplying electric energy.

Although the present invention has been described with reference to a specific embodiment, it should be noted that the described embodiment is not necessarily exclusive and that various changes and modifications may be made to the described embodiment without departing from the scope of the invention as defined by the appended claims.

1. A flywheel energy storage system comprising:
a driving wheel rotatable relative to a first axis;
an electric motor for driving the driving wheel;
an electric generator for supplying electrical power;
a flywheel rotatable relative to a second axis parallel to the first axis;
a clutch assembly for engagement or disengagement of the flywheel and the electric generator; and
a transmission gear train assembly engagingly interposed between the flywheel and the driving wheel adapted for conveying a driving force from the driving wheel to the flywheel.

2. The flywheel energy storage system as recited in claim 1, wherein the transmission gear assembly comprises a common transmission shaft rotatable about a third axis parallel to the first and second axes; a first gear train comprising a first input gear adapted to be driven by the driving wheel, a first output gear coupled to the flywheel, a first compound gear coupled to the common transmission shaft, the first compound gear having a small diameter gear portion meshing with the first input gear and an coaxial larger diameter gear portion meshing with the first output gear; and a second gear train comprising a second input gear coupled to the common transmission shaft, a second output gear adapted to drive the flywheel, a second compound gear having a small diameter gear portion meshing with the second input gear and an coaxial larger diameter gear portion meshing with the second output gear.

3. The flywheel energy storage system as recited in claim 1, wherein the gears are substituted with a wheel and belt arrangement.

4. The flywheel energy storage system as recited in claim 1, wherein the second gear train comprises a one-way bearing, the second output gear is supported by the one-way bearing for allowing the first and second output gears to rotate at differential speeds.

5. The flywheel energy storage system as recited in claim 1, further comprising a storage battery for supplying power to the electric motor or customer load, and a battery charger electrically connected to the storage battery for charging the storage battery.

6. The flywheel energy storage system as recited in claim 1, wherein the transmission gear train assembly comprises a common transmission shaft rotatable about a third axis parallel to the first and second axes; a first gear train comprising a first input gear adapted to be driven by the driving wheel, a first output gear coupled to the flywheel, at least two first compound gears meshing with each other, each of the first compound gears including a small diameter gear portion and an coaxial large diameter gear portion, wherein a first compound gear nearest the first input gear is coupled to the common transmission shaft, the at least two first compound gears are assembled as one unit in a manner that a larger diameter gear portion of one of two neighboring first compound gears meshes with a small diameter gear portion of the other and a small diameter gear portion of a first compound gear nearest to the first input gear meshes with the first input gear and a large diameter gear portion of a first compound gear nearest to the first output gear meshes with the first output gear; and a second gear train comprising a second input gear coupled to the common transmission shaft, a second output gear adapted to drive the flywheel, and at least two second compound gears meshing with each other, each of the second compound gears including a small diameter gear portion and an coaxial large diameter gear portion, wherein the at least two first compound gears are assembled as one unit in a manner that a larger diameter gear portion of one of two neighboring second compound gears meshes with a small diameter gear portion of the other and a small diameter gear portion of a second compound gear nearest to the second input gear meshes with the second input gear and a large diameter gear portion of a second compound gear nearest to the second output gear meshes with the second output gear.

7. The flywheel energy storage system as recited in claim 5, wherein the second gear train comprises a one-way -bearing, the second output gear is supported by the one-way bearing for allowing the first and second output gears to rotate at differential speeds.

8. The flywheel energy storage system comprising:
a driving shaft rotatable about a first axis;
a driving wheel coupled to the driving shaft for rotation therewith;
an electric motor for driving the driving wheel;
an electric generator electrically connected to the battery charger for supplying power to the battery charger;
a driven shaft rotatable about a second axis parallel to the first axis;
a driven wheel coupled to the driven shaft for rotation therewith for powering the electric generator;
a flywheel rotatable relative to the driven shaft;
a clutch assembly for engagement or disengagement of the flywheel and the driven shaft; and
a transmission gear train assembly engagingly interposed between the flywheel and the driving wheel adapted for conveying a driving force from the driving wheel to the flywheel.

9. The flywheel energy storage system as recited in claim 7, wherein the transmission gear assembly comprises
a common transmission shaft rotatable about a third axis parallel to the first and second axes;
a first gear train comprising a first input gear coupled to the driving shaft, a first output gear coupled to the flywheel, a first compound gear coupled to the common transmission shaft, the first compound gear having a small diameter gear portion meshing with the first input gear and an coaxial larger diameter gear portion meshing with the first output gear; and
a second gear train comprising a second input gear coupled to the common transmission shaft, a second output gear mounted to the driven shaft, a second compound gear having a small diameter gear portion meshing with the second input gear and an coaxial larger diameter gear portion meshing with the second output gear.

10. The flywheel energy storage system as recited in claim 8, wherein the second gear train comprises a one-way bearing, the second output gear is supported by the one-way bearing for allowing the first and second output gears to rotate at differential speeds.

11. The flywheel energy storage system as recited in claim 7, further comprising a storage battery for supplying power to the electric motor or customer load, and a battery charger electrically connected to the storage battery for charging the storage battery.

12. The flywheel energy storage system as recited in claim 7, wherein the transmission gear assembly comprises
a common transmission shaft rotatable about a third axis parallel to the first and second axes;
a first gear train comprising a first input gear adapted to be driven by the driving wheel, a first output gear coupled to the flywheel, at least two first compound gears meshing with each other, each of the first compound gears including a small diameter gear portion and an coaxial large diameter gear portion, wherein a first compound gear nearest the first input gear is coupled to the common transmission shaft, the at least two first compound gears are assembled as one unit in a manner that a larger diameter gear portion of one of two neighboring first compound gears meshes with a small diameter gear portion of the other and a small diameter gear portion of a first compound gear nearest to the first input gear meshes with the first input gear and a large diameter gear portion of a first compound gear nearest to the first output gear meshes with the first output gear; and
a second gear train comprising a second input gear coupled to the common transmission shaft, a second output gear mounted to the driven shaft, and at least two second compound gears meshing with each other, each of the second compound gears including a small diameter gear portion and an coaxial large diameter gear portion, wherein the at least two first compound gears are assembled as one unit in a manner that a larger diameter gear portion of one of two neighboring second compound gears meshes with a small diameter gear portion of the other and a small diameter gear portion of a second compound gear nearest to the second input gear meshes with the second input gear and a large diameter gear portion of a second compound gear nearest to the second output gear meshes with the second output gear.

13. The flywheel energy storage system as recited in claim 11, wherein the second gear train comprises a one-way bearing, the second output gear is supported by the one-way bearing for allowing the first and second output gears to rotate at differential speeds.

14. A flywheel energy storage system comprising:
a frame having first, second and third parallel axes;
a driving shaft rotatable about the first axis;
a driving wheel coupled to the driving shaft for rotation therewith;
an electric motor for driving the driving wheel;
an electric generator for supplying power;
a driven shaft rotatable about the second axis;
a driven wheel coupled to the driven shaft for powering the electric generator;
a flywheel rotatably mounted on the driven shaft;
a clutch assembly for engagement or disengagement of the flywheel and the driven shaft; and
a transmission gear assembly engagingly interposed between the flywheel and the driving wheel adapted for conveying a driving force from the driving wheel to the flywheel.

15. The flywheel energy storage system as recited in claim 14, wherein the transmission gear assembly comprises
a common transmission shaft rotatable about a third axis parallel to the first and second axes;
a first gear train comprising a first input gear coupled to the driving shaft, a first output gear coupled to the flywheel, a first compound gear coupled to the common transmission shaft, the first compound gear having a small diameter gear portion meshing with the first input gear and an coaxial larger diameter gear portion meshing with the first output gear; and
a second gear train comprising a second input gear coupled to the common transmission shaft, a second output gear mounted to the driven shaft, a second compound gear having a small diameter gear portion meshing with the second input gear and an coaxial larger diameter gear portion meshing with the second output gear.

16. The flywheel energy storage system as recited in claim 15, wherein the second gear train comprises a one-way bearing, the second output gear is supported by the one-way bearing for allowing the first and second output gears to rotate at differential speeds.

17. The flywheel energy storage system as recited in claim 14, further comprising a storage battery for supplying power to the electric motor or customer load, and a battery charger electrically connected to the storage battery for charging the storage battery.

18. The flywheel energy storage system as recited in claim 14, wherein the transmission gear assembly comprises
a common transmission shaft rotatable about a third axis parallel to the first and second axes;
a first gear train comprising a first input gear adapted to be driven by the driving wheel, a first output gear coupled to the flywheel, at least two
first compound gears meshing with each other, each of the first compound gears including a small diameter gear portion and an coaxial large diameter gear portion, wherein a first compound gear nearest the first input gear is coupled to the common transmission shaft, the at least two first compound gears are assembled as one unit in a manner that a larger diameter gear portion of one of two neighboring first compound gears meshes with a small diameter gear portion of the other and a small diameter gear portion of a first compound gear nearest to the first input gear meshes with the first input gear and a large diameter gear portion of a first compound gear nearest to the first output gear meshes with the first output gear; and
a second gear train comprising a second input gear coupled to the common transmission shaft, a second output gear mounted to the driven shaft, and at least two second compound gears meshing with each other, each of the second compound gears including a small diameter gear portion and an coaxial large diameter gear portion, wherein the at least two first compound gears are assembled as one unit in a manner that a larger diameter gear portion of one of two neighboring second compound gears meshes with a small diameter gear portion of the other and a small diameter gear portion of a second compound gear nearest to the second input gear meshes with the second input gear and a large diameter gear portion of a second compound gear nearest to the second output gear meshes with the second output gear.

19. The flywheel energy storage system as recited in claim 18, wherein the second gear train comprises a one-way bearing, the second output gear is supported by the one-way bearing for allowing the first and second output gears to rotate at differential speeds.
